(19) United States
(12) Patent Application Publication
(10) Pub. No.: US 2016/0291869 A1
(43) Pub. Date: Oct. 6, 2016

(54) DATA STORAGE DEVICE AND DATA PROCESSING SYSTEM INCLUDING THE SAME

(71) Applicant: SAMSUNG ELECTRONICS CO., LTD., SUWON-SI (KR)

(72) Inventors: Hyun Ju YI, Hwaseong-si (KR); Seok Won AHN, Suwon-si (KR); Chan Ho YOON, Seoul (KR); Jung Pil LEE, Hwaseong-si (KR); Jun Ho CHOI, Seoul (KR)

(21) Appl. No.: 15/007,241

(22) Filed: Jan. 27, 2016

(30) Foreign Application Priority Data
Apr. 6, 2015 (KR) 10-2015-0048334

(51) Int. Cl. G06F 3/06

(52) U.S. Cl. CPC G06F 3/061; G06F 3/0659; G06F 3/0688

(57) ABSTRACT

A data storage device includes a first scale-out controller configured to control a first non-volatile memory and a first volatile memory, a second scale-out controller configured to control a second non-volatile memory and a second volatile memory, and a controller configured to set a first memory management policy for the first non-volatile memory to be different from a second memory management policy for the second non-volatile memory.

### CROSS-REFERENCE TO RELATED APPLICATION

A claim of priority under 35 U.S.C. §119 is made to Korean Patent Application No. 10-2015-0048334 filed on Apr. 6, 2015 in the Korean Intellectual Property Office, the entire contents of which are hereby incorporated by reference.

### BACKGROUND

The inventive concepts described herein relate to a data storage device, and more particularly, to a data storage device for increasing the quality of service (QoS) and saving memory resources of a controller, and a data processing system including the same.

Memory devices are used to store data, and are generally classified as either volatile memory devices or non-volatile memory devices. A flash memory device is an example of electrically erasable programmable read-only memory (EEPROM) in which a plurality of memory cells are erased or programmed in a single program operation.

In order to increase the capacity of conventional drives including non-volatile memory devices (e.g., flash memory devices), the number of non-volatile memory devices needs to be increased. When the number of non-volatile memory devices included in a drive is increased, it is necessary to increase the capacity (or size) of a mapping table which includes information about translation of logical addresses into physical addresses. However, the number of non-volatile memory devices cannot be increased indefinitely when the capacity of memory storing the mapping table and the processing speed of the memory are considered.

Scale-up and scale-out are techniques used to increase the data processing performance of a data storage device, e.g. a data server. Scale-up is a method of increasing the data processing performance of a data server by increasing the capacity of the data server itself, and is referred to as vertical scaling. Scale-out is a method of increasing the data processing performance of a system including a data server by increasing the number of connected data servers, and is referred to as horizontal scaling.

When the number of non-volatile memory devices increases in a data storage device having scale-up architecture, loading capacitance of an interface between the non-volatile memory devices and a controller which controls the non-volatile memory devices increases. As a result, the data processing speed of the data storage device may decrease.

### SUMMARY

Embodiments of the inventive concept provide a data storage device including a first scale-out controller configured to control a first non-volatile memory and a first volatile memory, a second scale-out controller configured to control a second non-volatile memory and a second volatile memory, and a controller configured to set a first memory management policy for the first non-volatile memory to be different from a second memory management policy for the second non-volatile memory.

In some embodiments of the inventive concept, the first scale-out controller may be configured to set the first memory management policy for the first non-volatile memory based on a first command output from the controller, and the second scale-out controller may be configured to set the second memory management policy for the second non-volatile memory based on a second command output from the controller.

In some embodiments of the inventive concept, the controller may be configured to generate the first command and the second command based on a total usable memory capacity of the data storage device.

In some embodiments of the inventive concept, the first scale-out controller may be configured to transmit, to the controller, information about a first free space generated in the first volatile memory according to the first memory management policy. The second scale-out controller may be configured to transmit, to the controller, information about a second free space generated in the second volatile memory according to the second memory management policy.

In some embodiments of the inventive concept, the first memory management policy may be a first flash translation layer (FTL) mapping policy for the first non-volatile memory, and the second memory management policy may be a second FTL mapping policy for the second non-volatile memory.

In some embodiments of the inventive concept, the first FTL mapping policy may indicate a first size of units by which first data stored in the first non-volatile memory is managed. The second FTL mapping policy may indicate a second size of units by which second data stored in the second non-volatile memory is managed.

Alternatively, in some embodiments of the inventive concept, the first FTL mapping policy may be one policy from among a page-level mapping policy, a block-level mapping policy, and a hybrid mapping policy. The second FTL mapping policy may be another policy from among the page-level mapping policy, the block-level mapping policy, and the hybrid mapping policy. The first volatile memory and the first scale-out controller may be packaged into a first package, and the second volatile memory and the second scale-out controller may be packaged into a second package.

In some embodiments of the inventive concept, the first scale-out controller may be configured to determine whether to program first data to the first non-volatile memory in one mode from among a sequential program mode and a random program mode based on the first memory management policy, and the second scale-out controller may be configured to determine whether to program second data to the second non-volatile memory in an other mode from among the sequential program mode and the random program mode based on the second memory management policy.

In some embodiments of the inventive concept, the first scale-out controller may be configured to determine whether to program first data having a first access frequency to the first non-volatile memory based on the first memory management policy, and the second scale-out controller may be configured to determine whether to program second data having a second access frequency different from the first access frequency to the second non-volatile memory based on the second memory management policy.

In some embodiments of the inventive concept, the first scale-out controller may be configured to determine a ratio of the number of second memory cells storing 1-bit information to the number of third memory cells storing information of at least two bits among first non-volatile memory cells included in the first non-volatile memory based on the first memory management policy. The second scale-out controller may be configured to determine a ratio of a number of fifth memory cells storing 1-bit information to a number of sixth memory cells storing information of at least two bits among fourth non-volatile memory cells included in the second non-volatile memory based on the second memory management policy.

In some embodiments of the inventive concept, the first memory management policy and the second memory management policy may be respective different error control coding (ECC) code rates.

In some embodiments of the inventive concept, the first non-volatile memory may include a first three-dimensional memory cell array including first memory cells, and the second non-volatile memory may include a second three-dimensional memory cell array including second memory cells.

Embodiments of the inventive concept provide a data processing system including a data storage device and a host connected to the data storage device via an interface. The data storage device includes a first scale-out controller configured to control a first non-volatile memory and a first volatile memory, a second scale-out controller configured to control a second non-volatile memory and a second volatile memory, and a controller configured to set a first memory management policy for the first non-volatile memory to be different from a second memory management policy for the second non-volatile memory.

In some embodiments of the inventive concept, the first scale-out controller may be configured to set the first memory management policy for the first non-volatile memory based on a first command output from the controller, and the second scale-out controller may be configured to set the second memory management policy for the second non-volatile memory based on a second command output from the controller.

Embodiments of the inventive concept provide a data storage device including a first scale-out controller configured to control a first non-volatile memory and a first volatile memory, a second scale-out controller configured to control a second non-volatile memory and a second volatile memory, and a controller. The controller is configured to detect a total usable memory capacity of the data storage device, determine a partitioning policy of the data storage device responsive to the detected total usable memory capacity, and to determine respective first and second memory management policies. The first scale-out controller is configured to control the first non-volatile and volatile memories according to the first memory management policy, and the second scale-out controller is configured to control the second non-volatile and volatile memories according to the second memory management policy.

### BRIEF DESCRIPTION OF THE DRAWINGS

The above and other features and advantages of the inventive concept will become more apparent from the following detailed description taken in conjunction with the accompanying figures, in which:

FIG. 1 illustrates a block diagram of a data processing system, according to embodiments of the inventive concept;

FIG. 2 illustrates a conceptual diagram of a memory cluster including devices having different memory management policies, according to embodiments of the inventive concept;

FIG. 3 illustrates a block diagram of a first cluster shown in FIG. 1, according to embodiments of the inventive concept;

FIG. 4 illustrates a block diagram of a first scale-out device shown in FIG. 3, according to embodiments of the inventive concept;

FIG. 5 illustrates a diagram of a package for the first scale-out device shown in FIG. 3, according to embodiments of the inventive concept;

FIG. 6 illustrates a diagram of a package including a controller shown in FIG. 2 and a first scale-out storage device, according to embodiments of the inventive concept;

FIG. 7 illustrates a block diagram of a first scale-out controller shown in FIG. 4, according to embodiments of the inventive concept;

FIG. 8 illustrates a diagram of volatile memory devices included in the first scale-out controller shown in FIG. 4, according to embodiments of the inventive concept;

FIGS. 9A, 9B and 9C illustrate diagrams of examples of a volatile memory shown in FIG. 4, which have different free spaces depending on different map sizes, according to embodiments of the inventive concept;

FIG. 10 illustrates a diagram showing a ratio of a single-level cell (SLC) region to a multi-level cell (MLC) region in non-volatile memory shown in FIG. 3;

FIG. 11 illustrates a block diagram of a data processing system, according to embodiments of the inventive concept;

FIG. 12 illustrates a conceptual diagram of the operation of a data storage device shown in FIG. 1 or 11, according to embodiments of the inventive concept; and

FIG. 13 illustrates a block diagram of a data processing system, according to further embodiments of the inventive concept.

### DETAILED DESCRIPTION

The inventive concept will be described more fully hereinafter with reference to the accompanying drawings. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It should be understood that, although the terms first, second, etc. may be used herein to describe various elements, such elements should not be limited by these terms. These terms are only used to distinguish one element from another. For example, a first signal may be termed a second signal, and, similarly, a second signal may be termed a first signal without departing from the teachings of the disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It should be further understood that the terms “comprises” and/or “comprising,” or “includes” and/or “including” when used in this specification, specify the presence of stated features, regions, integers, steps, operations, elements, components and/or groups, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the inventive concepts belong. It should be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

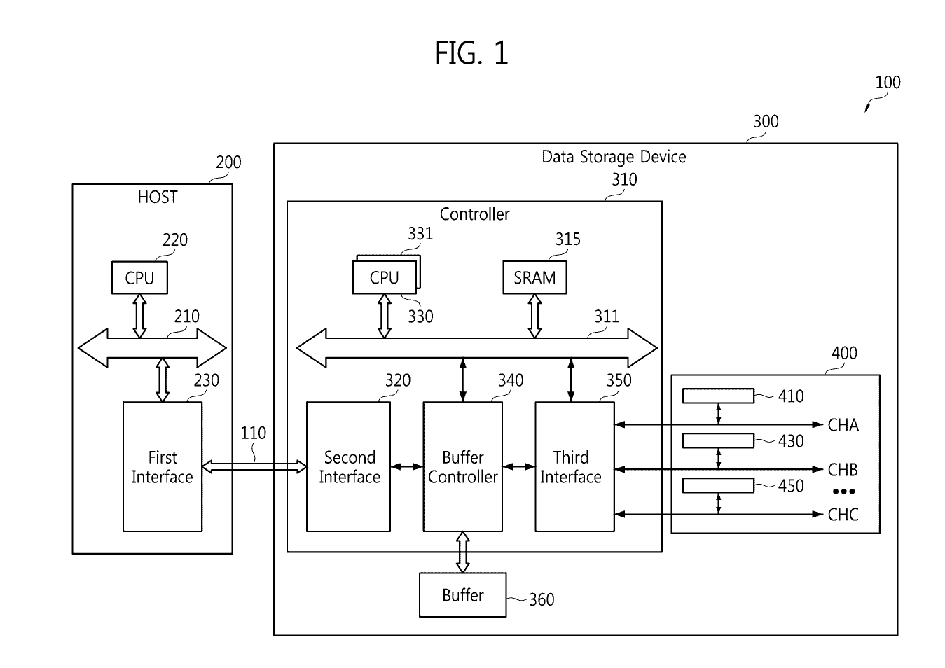

FIG. 1 illustrates a block diagram of a data processing system 100, according to embodiments of the inventive concept. Referring to FIG. 1, the data processing system 100 includes a host 200, and a data storage device 300 which communicates a command and/or data with the host 200 via an interface 110. The data storage device 300 may have scale-out architecture. The data processing system 100, which will be described hereinafter, may be used in a personal computer (PC), a workstation, a data center, an internet data center, a storage area network (SAN), or a network-attached storage (NAS), but the inventive concept is not restricted to such embodiments.

The interface 110 may be a serial advanced technology attachment (SATA) interface, a SATA express (SATAe) interface, a SAS interface (serial attached small computer system interface (SCSI)), a peripheral component interconnect express (PCIe) interface, a non-volatile memory express (NVMe) interface, or an advanced host controller interface (AHCI), but is not restricted thereto. The interface 110 may transmit electrical or optical signals.

The host 200 controls a data processing operation (e.g., a write or read operation) of the data storage device 300 via the interface 110. The host 200 includes a central processing unit (CPU) 220 and a first interface 230 which may communicate a command and/or data with each other via bus architecture (or a bus) 210. Although the host 200 includes the bus architecture 210, the CPU 220, and the first interface 230 in the embodiments illustrated in FIG. 1, the structure of the host 200 is not restricted to the current embodiments.

The host 200 may be implemented as an integrated circuit (IC), a motherboard, a system on chip (SoC), an application processor (AP), a mobile AP, a web server, a data server, or a database server, but the inventive concepts are not restricted to these examples. The host 200 may be any type of device that can control the data storage device 300.

The bus architecture 210 may be implemented as an advanced microcontroller bus architecture (AMBA), an advanced high-performance bus (AHB), an advanced peripheral bus (APB), an advanced extensible interface (AXI), AXI coherency extensions (ACE), an advanced system bus (ASB), or a combination thereof, but is not restricted to these examples.

The CPU 220 may generate a write request for controlling a write operation of the data storage device 300, or a read request for controlling a read operation of the data storage device 300. The write request may include a write address and the read request may include a read address. The CPU 220 may include at least one core.

The first interface 230 may change the format of a command and/or data to be transmitted to the data storage device 300, and may transmit the command and/or data in a changed format to the data storage device 300 through the interface 110. The first interface 230 may also change the format of a response and/or data received from the data storage device 300 and may transmit the response and/or data in a changed format to the CPU 220 through the bus architecture 210. The first interface 230 may include a transceiver which transmits and receives a command and/or data. The structure and operations of the first interface 230 may be configured to be compatible with those of the interface 110.

The data storage device 300 includes a controller 310, a buffer 360, and memory cluster 400. The memory cluster 400 may be a group of memory chips, memory devices, memory packages, or scale-out storage devices (or multi-chip sets).

The data storage device 300 may be a flash memory-based data storage device, but is not restricted thereto. The data storage device 300 may be implemented as a solid-state drive or solid-state disk (SSD), an embedded SSD (eSSD), a universal flash storage (UFS), a multimedia card (MMC), or an embedded MMC (eMMC), but is not restricted to these examples. The flash memory-based data storage device may be a NAND-type flash memory device or a NOR-type flash memory device. Alternatively, the data storage device 300 may be implemented as a hard disk drive (HDD), a phase-change random access memory (PRAM) device, a magnetoresistive RAM (MRAM) device, a spin-transfer torque MRAM (STT-MRAM) device, a ferroelectric RAM (FRAM) device, or a resistive RAM (RRAM) device, but the type of the data storage device 300 is not restricted to these examples.

The controller 310 controls transfer of a command and/or data among the host 200, the buffer 360, and the memory cluster 400. The controller 310 may be implemented in an IC, a SoC, or a package including electronic circuits.

The controller 310 includes bus architecture 311, an internal memory 315, a second interface 320, at least one CPU 330 and/or 331, a buffer controller 340, and a third interface 350. Here, an interface may be a device or controller which controls transmission of a command and/or data, but is not restricted thereto. The bus architecture 311 may be implemented as AMBA, AHB, APB, AXI, ACE, ASB, or combination thereof, as described above, but is not restricted to these examples.

The internal memory 315 may store data necessary for the operations of the controller 310 or data generated from a data processing operation (e.g. a write or read operation) performed by the controller 310. The internal memory 315 may be implemented as RAM, dynamic RAM (DRAM), static RAM (SRAM), buffer, buffer memory, cache, or tightly couple memory (TCM), but is not restricted to these examples.

The second interface 320 may change the format of a response and/or data to be transmitted to the host 200, and may transmit the response and/or data in a changed format to the host 200 through the interface 110. The second interface 320 may also receive a command and/or data from the host 200, change the format of the command and/or data, and transmit the command and/or data in a changed format to the at least one CPU 330 and/or 331 and/or the buffer controller 340. The second interface 320 may include a transceiver which transmits and receives a signal and/or data.

The structure and operations of the second interface 320 may be configured to be compatible with those of the interface 110. The second interface 320 may be SATA interface, SATAe interface, SAS, PCIe interface, NVMe interface, AHCI, NAND-type flash memory interface, or NOR-type flash memory interface, but is not restricted thereto.

The at least one CPU 330 and/or 331 controls the internal memory 315, the second interface 320, the buffer controller 340, and the third interface 350 through the bus architecture 311. The at least one CPU 330 and/or 331 may include at least one core.

The first CPU 330 may control transmission of a command and/or data from or to the host 200 via the second interface 320, and the second CPU 331 may control transmission of a command and/or data from or to the memory cluster 400 via the third interface 350. The first CPU 330 and the second CPU 331 may form a multi-CPU. The first CPU 330 may control the second CPU 331, but the inventive concept is not restricted to this embodiment.

The buffer controller 340 may writes data to or reads data from the buffer 360 according to the control of the first or second CPU 330 or 331. The buffer controller 340 may controls the write and read operations on the buffer 360 and may be called a buffer manager.

The third interface 350 controls a data processing operation (e.g. a write or read operation) on the memory cluster 400 through one of a plurality of main channels CHA, CHB, . . . , CHC according to the control of the first or second CPU 330 or 331. The third interface 350 may be SATA interface, SATAe interface, SAS, PCIe interface, NVMe interface, AHCI, NAND-type flash memory interface, or NOR-type flash memory interface, but is not restricted thereto.

The buffer 360 stores data or read data according to the control of the buffer controller 340. The buffer 360 may be implemented as volatile memory such as RAM, SRAM, DRAM, or buffer memory, but is not restricted to these examples.

The buffer 360 may include a first region which stores a mapping table for logical address-to-physical address translation with respect to a plurality of clusters 410, 430, . . . , 450, and a second region which functions as a cache. The mapping table may be a flash translation layer (FTL) mapping table. The at least one CPU 330 and/or 331 may execute an FTL and the FTL may perform logical address-to-physical address translation (or mapping) using the FTL mapping table. The FTL may be stored in memory (e.g., the internal memory 315) that can be accessed by the at least one CPU 330 and/or 331 or in the memory cluster 400.

When the controller 310 and the buffer 360 are formed in different semiconductor chips, respectively; the controller 310 and the buffer 360 may be implemented in a single package using package-on-package (PoP), multi-chip package (MCP), or system-in package (SiP), but the type of packages is not restricted to these examples. A first chip including the buffer 360 may be stacked above a second chip including the controller 310 using stack balls.

The memory cluster 400 may include a plurality of the clusters 410, 430, . . . , 450. The first cluster 410 may be connected to the first main channel CHA, the second cluster 430 may be connected to the second main channel CHB, and the third cluster 450 may be connected to the third main channel CHC.

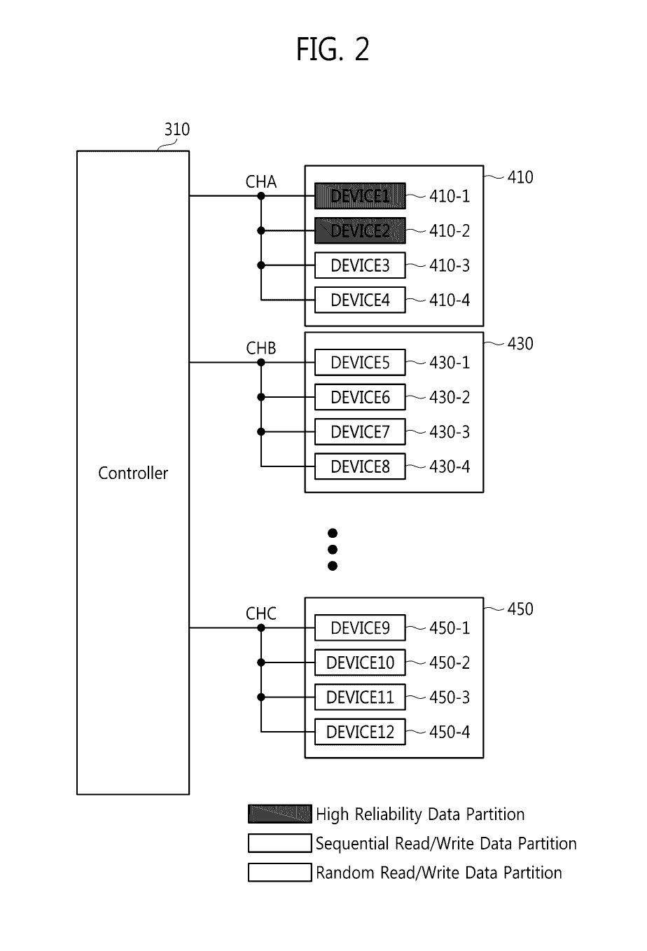

A main channel may just be called a channel and may refer to an independent data path existing between the controller 310 or the third interface 350 and each of the clusters 410, 430, . . . , 450. The data path may include transmission lines that transmit data and/or control signals. The term “way” may refer to a non-volatile memory or a group of non-volatile memories sharing one main channel (or one channel). Accordingly, a plurality of ways may be connected to one main channel. The structure and operations of each of the clusters 410, 430, and 450 will be described in detail with reference to FIGS. 2 through 10.

FIG. 2 illustrates a conceptual diagram of a memory cluster including devices having different memory management policies, according to embodiments of the inventive concept. The first cluster 410 includes a plurality of devices 410-1 through 410-4, the second cluster 430 includes a plurality of devices 430-1 through 430-4, and the third cluster 450 includes a plurality of devices 450-1 through 450-4. Each of the devices 410-1 through 410-4, 430-1 through 430-4, and 450-1 through 450-4 may be a scale-out storage device or a multi-chip set. Each of the devices 410-1 through 410-4, 430-1 through 430-4, and 450-1 through 450-4 may include a local FTL executed independently. Each local FTL may control logical address-to-physical address translation with respect to NAND-type flash memories included in each of the devices 410-1 through 410-4, 430-1 through 430-4, and 450-1 through 450-4. A logical address may be a logical block address (LBA) or a logical page number (LPN).

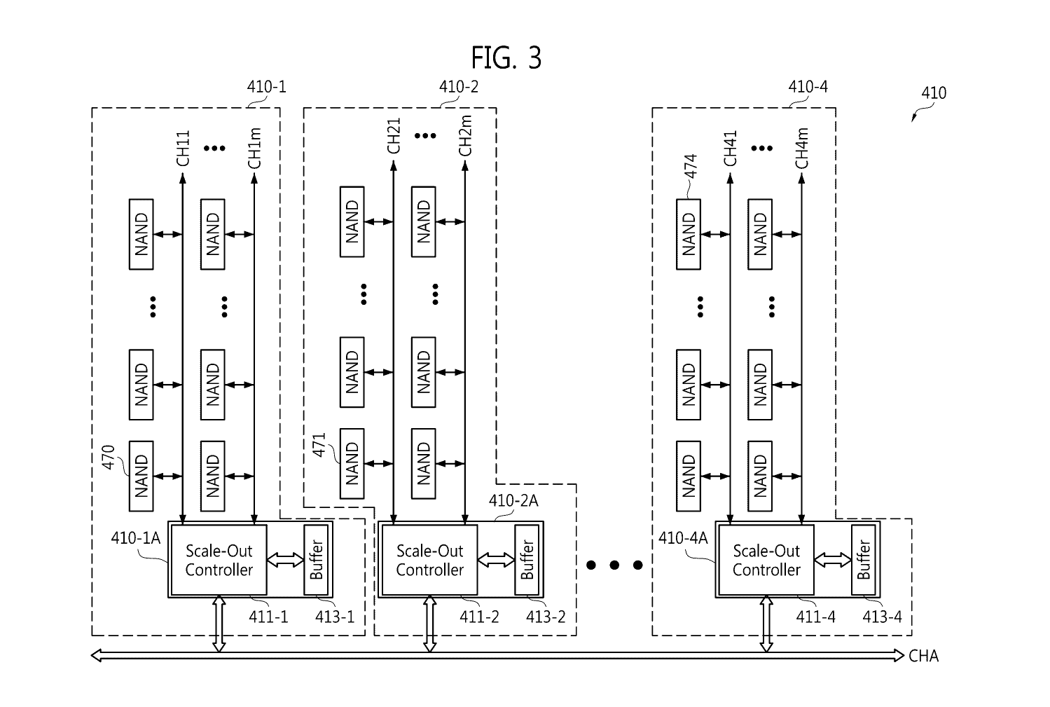

Although each of the clusters 410, 430, . . . , 450 includes four devices in the embodiments illustrated in FIG. 2, the number of devices included in each of the clusters 410, 430, and 450 may be variously changed. The clusters 410, 430, and 450 may include the same number of devices, or different numbers of devices. In embodiments of the inventive concept, a device (i.e., a scale-out storage device or a multi-chip set) may include various elements, such as a scale-out controller, a volatile memory, channels, and non-volatile memories, as shown in FIG. 3.

The controller 310 or the at least one CPU 330 and/or 331 may define or determine a different memory management policy for each of the devices 410-1 through 410-4, 430-1 through 430-4, and 450-1 through 450-4 included in the memory cluster 400. The memory management policy may be differently defined or determined according to the control of a user or the host 200. The memory management policy for each of the devices 410-1 through 410-4, 430-1 through 430-4, and 450-1 through 450-4 may be stored in the internal memory 315, the buffer 360, or the memory cluster 400 according to the control of the at least one CPU 330 and/or 331.

The memory management policies of embodiments of the inventive concept as will subsequently be described may include indication of: (1) whether data is accessed (e.g. written or read) sequentially or randomly; (2) whether an access frequency of data is high or low; (3) a ratio of the number of memory cells that program data in a single-level cell (SLC) mode and the number of memory cells that program data in a multi-level cell (MLC) mode; (4) whether an error control coding (ECC) code rate is high or low; and/or (5) whether FTL address mapping is managed by a page-level mapping policy, a block-level mapping policy, or a hybrid mapping policy. However, the memory management policy is not restricted to these examples.

Here, data may be classified as hot data or cold data based on an access frequency of the data written to or read from the memory cluster 400. The hot data may refer to data having a relatively high access frequency and the cold data may refer to data having a relatively low access frequency. The hot data may be stored in a first device in the memory cluster 400 and the cold data may be stored in a second device in the memory cluster 400.

The page-level mapping policy may be a policy or scheme of managing address mapping by pages of NAND-type flash memory. The block-level mapping policy may be a policy or scheme of managing address mapping by block of NAND-type flash memory. The hybrid mapping policy may be a policy or scheme of managing address mapping using a combination of the page-level mapping policy and the block-level mapping policy. A mapping policy may be determined for each device included in the memory cluster 400.

As shown in FIG. 2, the controller 310, or the at least one CPU 330 and/or 331, may define each of the devices 410-1 and 410-2 as a high reliability data partition, each of the devices 430-1 and 450-1 as a sequential read/write data partition, and each of the devices 410-3, 410-4, 430-2 through 430-4, and 450-2 through 450-4 as a random read/write data partition. The devices 410-1 and 410-2 defined as the high reliability data partition may increase error correction performance using a high ECC code rate or may program data to flash memory included therein in an SLC mode. The devices 430-1 and 450-1 defined as the sequential read/write data partition may manage data stored in flash memory included therein by units of a first size (e.g. of 8 or 16 KB). The devices 410-3, 410-4, 430-2 through 430-4, and 450-2 through 450-4 defined as the random read/write data partition may manage data stored in flash memory included therein by units of a second size (e.g. of 4 KB). The first size may be greater than the second size, and the first size and the second size may be included in an FTL address mapping policy.

FIG. 3 illustrates a block diagram of the first cluster 410 shown in FIG. 1, according to embodiments of the inventive concept. Referring to FIGS. 1 through 3, the structure and operations are substantially the same or similar among the clusters 410, 430, . . . , 450, and therefore, the structure and operations of the first cluster 410 will be described representatively. The first cluster 410 includes the devices 410-1 through 410-4, e.g. scale-out storage devices or multi-chip sets.

The first device 410-1 includes a first scale-out device 410-1A including a first scale-out controller 411-1 and a first volatile memory 413-1, channels CH11 through CH1m (where “m” is a natural number of at least 2), and first non-volatile memories NAND 470. The second device 410-2 includes a second scale-out device 410-2A including a second scale-out controller 411-2 and a second volatile memory 413-2, channels CH21 through CH2m, and second non-volatile memories NAND 471. The fourth device 410-4 may include a fourth scale-out device 410-4A including a fourth scale-out controller 411-4 and a fourth volatile memory 413-4, channels CH41 through CH4m, and fourth non-volatile memories NAND 474. Here, volatile or non-volatile memory may refer to a semiconductor chip or a semiconductor package including a semiconductor chip.

It is assumed that non-volatile memories illustrated in FIG. 3 are NAND-type flash memories. As described above, the non-volatile memories may be NAND-type flash memory chips or packages including NAND-type flash memory chips.

The first scale-out controller 411-1 is connected to the first main channel CHA, the channels CH11 through CH1m, and the first volatile memory 413-1. A plurality of NAND-type flash memories NAND 470 are connected to each of the channels CH11 through CH1m.

The first volatile memory 413-1 may include a first memory region to store logical address-to-physical address mapping information (or mapping table) regarding the NAND-type flash memories NAND connected to each of the channels CH11 through CH1m. The first volatile memory 413-1 may also include a second memory region (or a cache region) to temporarily store data to be written to at least one of the NAND-type flash memories NAND 470 connected to each of the channels CH11 through CH1m or data output from at least one of the NAND-type flash memories NAND 470 connected to each of the channels CH11 through CH1m.

The second scale-out controller 411-2 is connected to the first main channel CHA, the channels CH21 through CH2m, and the second volatile memory 413-2. A plurality of NAND-type flash memories NAND 471 are connected to each of the channels CH21 through CH2m.

The second volatile memory 413-2 may include a first memory region to store logical address-to-physical address mapping information (or mapping table) regarding the NAND-type flash memories NAND 471 connected to each of the channels CH21 through CH2m. The second volatile memory 413-2 may also include a second memory region (or a cache region) to temporarily store data to be written to at least one of the NAND-type flash memories NAND 471 connected to each of the channels CH21 through CH2m or data output from at least one of the NAND-type flash memories NAND 471 connected to each of the channels CH21 through CH2m.

The fourth scale-out controller 411-4 is connected to the first main channel CHA, the channels CH41 through CH4m, and the fourth volatile memory 413-4. A plurality of NAND-type flash memories NAND 474 are connected to each of the channels CH41 through CH4m.

The fourth volatile memory 413-4 may include a first memory region to store logical address-to-physical address mapping information (or mapping table) regarding the NAND-type flash memories NAND 474 connected to each of the channels CH41 through CH4m. The fourth volatile memory 413-4 may also include a second memory region (or a cache region) to temporarily store data to be written to at least one of the NAND-type flash memories NAND 474 connected to each of the channels CH41 through CH4m or data output from at least one of the NAND-type flash memories NAND 474 connected to each of the channels CH41 through CH4m.

Each of the volatile memories 413-1 through 413-4 may be a buffer or buffer memory, and may be formed of RAM, SRAM, or DRAM, but is not restricted to these examples.

The structures of the scale-out devices 410-1A through 410-4A are substantially the same as or similar to one another. Although each of the devices 410-1 through 410-4 includes “m” channels in the embodiments illustrated in FIG. 3, the devices 410-1 through 410-4 may include different numbers of channels. Here, the meaning of a channel may be the same as the meaning of a main channel.

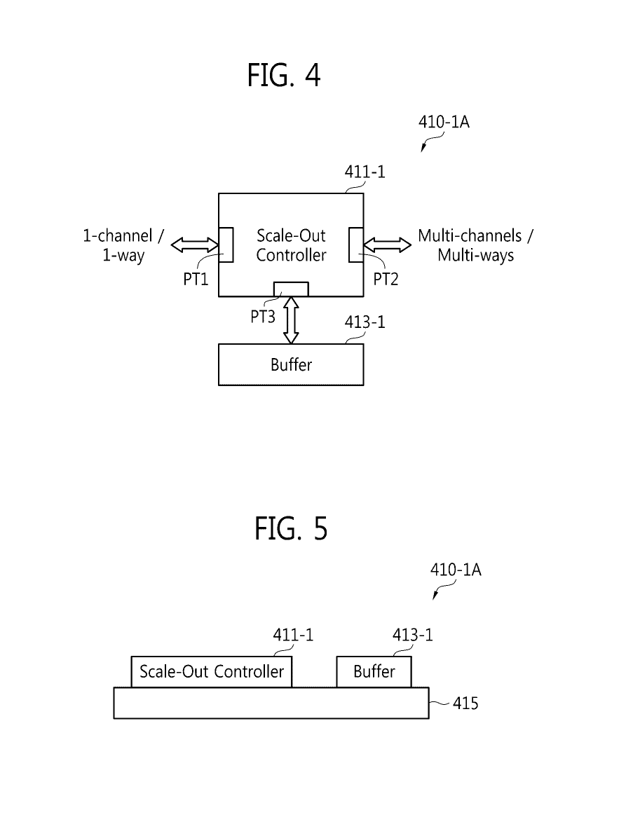

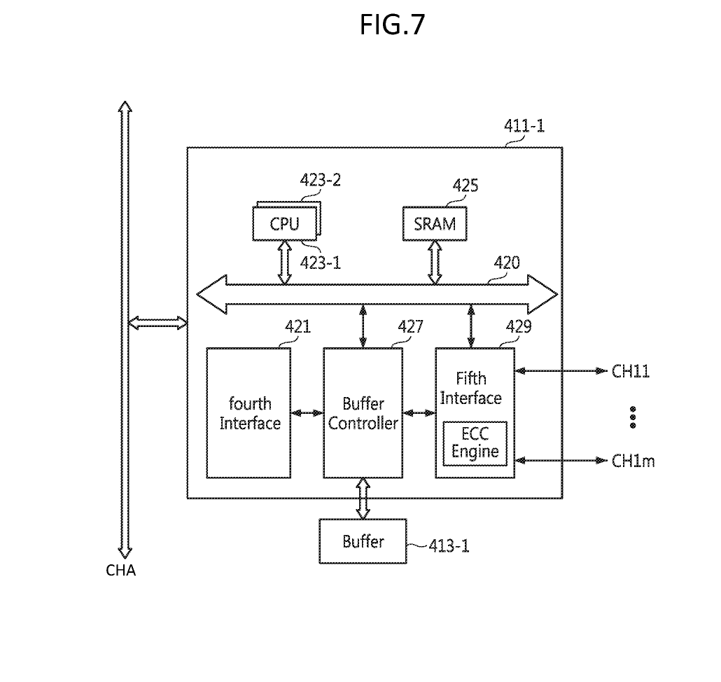

FIG. 4 illustrates a block diagram of the first scale-out device 410-1A shown in FIG. 3, according to embodiments of the inventive concept. FIG. 5 illustrates a diagram of a package for the first scale-out device 410-1A shown in FIG. 3, according to embodiments of the inventive concept. FIG. 7 illustrates a block diagram of the first scale-out controller 411-1 shown in FIG. 4, according to embodiments of the inventive concept.

Referring to FIGS. 1 through 5, the structure and operations are substantially the same or similar among the scale-out controllers 411-1 through 411-4, and therefore, the structure and operations of the first scale-out controller 411-1 will be described representatively. The first scale-out controller 411-1 illustrated in FIG. 4 includes first terminals (or first port) PT1 connected to a fourth interface 421 (as shown in FIG. 7), second terminals (or second port) PT2 connected to a fifth interface 429 (as shown in FIG. 7), and third terminals (or third port) PT3 connected to a buffer controller 427 (as shown in FIG. 7). Here, terminals may be pins or pads.

The first scale-out controller 411-1 controls transmission of a command and/or data communicated among the controller 310, the first volatile memory 413-1, and the NAND-type flash memories NAND 470. The first scale-out controller 411-1 may be implemented in an IC or a SoC.

As shown in FIG. 5, the first scale-out device 410-1A may be formed in a package. In detail, the first scale-out device 410-1A may include the first scale-out controller 411-1 and the first volatile memory 413-1 which are attached or mounted on a semiconductor substrate 415.

The first scale-out controller 411-1 may be attached on the semiconductor substrate 415 in a flip-chip structure. When the first scale-out controller 411-1 is attached on the semiconductor substrate 415 using an adhesive material, the first scale-out controller 411-1 may transmit or receive electrical signals to or from the semiconductor substrate 415 through bonding wires.

The first volatile memory 413-1 may also be attached to the semiconductor substrate 415 in a flip-chip structure. When the first volatile memory 413-1 is attached to the semiconductor substrate 415 using an adhesive material, the first volatile memory 413-1 may transmit or receive electrical signals to or from the semiconductor substrate 415 through bonding wires. In other words, the first scale-out controller 411-1 may communicate a command and/or data with the first volatile memory 413-1 via the semiconductor substrate 415.

Referring to FIG. 7, the first scale-out controller 411-1 includes bus architecture 420, the fourth interface 421, at least one CPU 423-1 and/or 423-2, an internal memory 425, a buffer controller 427, and the fifth interface 429. The bus architecture 420 may be implemented as AMBA, AHB, APB, AXI, ACE, ASB, or combination thereof, but is not restricted to these examples.

The fourth interface 421 may change the format of a response and/or data to be transmitted to the controller 310, and may transmit the response and/or data in a changed format to the controller 310 through the first main channel CHA. The fourth interface 421 may also receive a command and/or data from the controller 310, change the format of the command and/or data, and transmit the command and/or data in a changed format to the at least one CPU 423-1 and/or 423-2 and/or the buffer controller 427. The fourth interface 421 may include a transceiver which transmits and receives a signal and/or data.

The structure and operations of the fourth interface 421 may be configured to be compatible with those of the third interface 350. The fourth interface 421 may be SATA interface, SATAe interface, SAS, PCIe interface, NVMe interface, AHCI, NAND-type flash memory interface, or NOR-type flash memory interface, but is not restricted thereto. The fourth interface 421 may be connected to a channel (or a main channel) or a way.

The at least one CPU 423-1 and/or 423-2 controls the fourth interface 421, the internal memory 425, the buffer controller 427, and the fifth interface 429 through the bus architecture 420. The at least one CPU 423-1 and/or 423-2 may include at least one core. The at least one CPU 423-1 and/or 423-2 may execute an FTL. The FTL may perform address mapping using logical address-to-physical address mapping information (or mapping table) with respect to the NAND-type flash memories NAND 470 included in the first device 410-1. When the FTL is stored in the internal memory 425, the at least one CPU 423-1 and/or 423-2 may execute the FTL.

The first CPU 423-1 may communicate a command and/or data with the third interface 350 via the fourth interface 421 and the second CPU 423-2 may communicate a command and/or data with the NAND-type flash memories NAND 470 connected to each of the channels CH11 through CH1m via the fifth interface 429. The first CPU 423-1 and the second CPU 423-2 may form a multi-CPU. The first CPU 423-1 may control the second CPU 423-2, but the inventive concept is not restricted to this embodiment.

The internal memory 425 may store data necessary for the operations of the first scale-out controller 411-1 or data generated from a data processing operation (e.g. a write or read operation) performed by the first scale-out controller 411-1. The internal memory 425 may be implemented as RAM, DRAM, SRAM, buffer, buffer memory, cache, or TCM, but is not restricted to these examples.

The buffer controller 427 may write data to or read data from the first volatile memory 413-1 according to the control of the first or second CPU 423-1 or 423-2. The buffer controller 427 may control the write and read operations on the first volatile memory 413-1 and may be called a buffer manager.

The fifth interface 429 controls a data processing operation on the NAND-type flash memories NAND through one of the channels CH11 through CH1m according to the control of the first or second CPU 423-1 or 423-2. An ECC engine may be formed in the fifth interface 429.

As shown in FIG. 4, a plurality of channels and/or ways may be connected to the fifth interface 429. The fifth interface 429 may be SATA interface, SATAe interface, SAS, PCIe interface, NVMe interface, AHCI, NAND-type flash memory interface, or NOR-type flash memory interface, but is not restricted thereto.

When the first scale-out controller 411-1 and the first volatile memory 413-1 are formed in different chips, respectively in other embodiments, the first scale-out controller 411-1 and the first volatile memory 413-1 may be formed in a single package using PoP, MCP, or SiP, but the inventive concept is not restricted to these examples.

When at least one of the NAND-type flash memories NAND shown in FIG. 3 is replaced with a scale-out device (e.g. 410-1A), the scalability of memory capacity of the memory cluster 400 will increase.

The structure of the controller 310 may be substantially the same as or similar to that of the first scale-out controller 411-1.

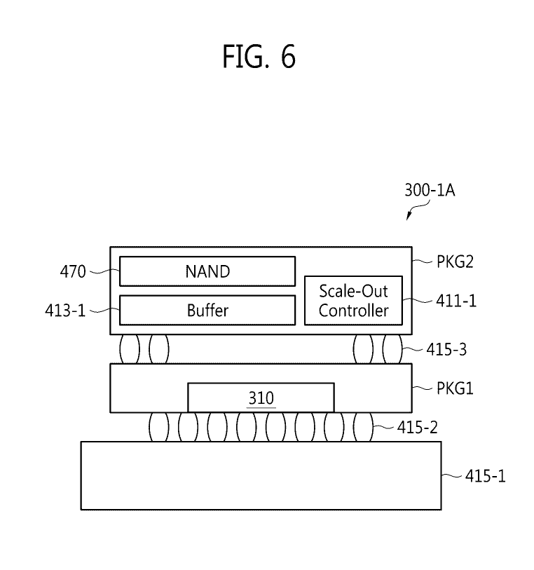

FIG. 6 illustrates a diagram of a package 300-1A including the controller 310 shown in FIG. 2 and a first scale-out storage device, according to embodiments of the inventive concept. Referring to FIGS. 2 through 6, the package 300-1A may be an embedded PoP (ePoP), but is not restricted thereto. The ePoP 300-1A includes a semiconductor substrate 415-1, a first package PKG1 placed over the semiconductor substrate 415-1, and a second package PKG2 placed over the first package PKG1. The first package PKG1 is bonded to the semiconductor substrate 415-1 using first bumps 415-2. The second package PKG2 is bonded to the first package PKG1 using second bumps 415-3. The first package PKG1 may include the controller 310. The second package PKG2 includes the first scale-out controller 411-1, the buffer 413-1, and at least one NAND-type flash memory 470. The second package PKG2 may also include the buffer 360 in other embodiments.

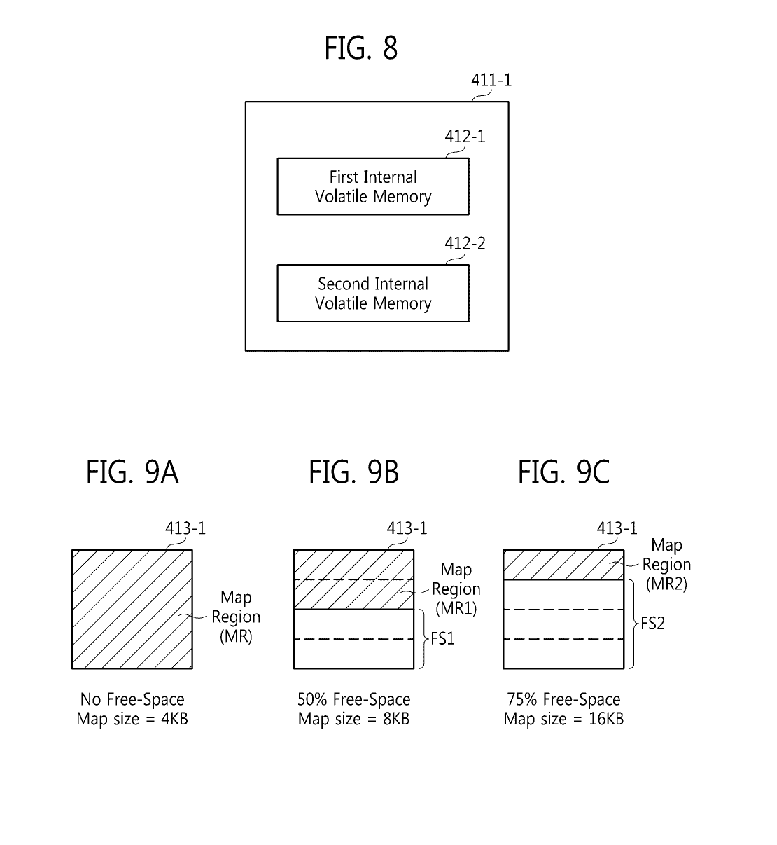

FIG. 8 illustrates a diagram of volatile memory devices included in the first scale-out controller 411-1 shown in FIG. 4, according to embodiments of the inventive concept. Referring to FIG. 8, the first scale-out controller 411-1 includes a first internal volatile memory 412-1 and a second internal volatile memory 412-2. The first internal volatile memory 412-1 may be a memory space for the first scale-out controller 411-1 and the second internal volatile memory 412-2 may be a memory space for the controller 310.

The first internal volatile memory 412-1 and the second internal volatile memory 412-2 are formed within the first scale-out controller 411-1 according to the embodiment illustrated in FIG. 8. However, at least one of the first and second internal volatile memories 412-1 and 412-2 may be the first volatile memory 413-1 or the internal memory 425 in other embodiments of the inventive concept. The first internal volatile memory 412-1 may be the internal memory 425 and the second internal volatile memory 412-2 may be the first volatile memory 413-1 in further embodiments.

The second internal volatile memory 412-2 may be used by the controller 310 for fast read latency or fast write latency. In detail, the controller 310 may use the second internal volatile memory 412-2 as a cache or cache memory.

FIGS. 9A through 9C illustrate diagrams of examples of the volatile memory 413-1 shown in FIG. 4, which have different free spaces depending on different map sizes, according to embodiments of the inventive concept. It is assumed that the first volatile memory 413-1 has a memory capacity of 2 gigabytes (GB).

Referring to FIG. 9A, when NAND-type flash memory NAND 470 connected to the first scale-out controller 411-1 is assigned as a random read/write data partition and data stored in the NAND-type flash memory NAND 470 is managed by units of 4 KB, an FTL map table managed by units of 4 KB is stored in a map region MR, and therefore, there is no free space in the first volatile memory 413-1.

Referring to FIG. 9B, when NAND-type flash memory NAND 470 connected to the first scale-out controller 411-1 is assigned as a sequential read/write data partition and data stored in the NAND-type flash memory NAND 470 is managed by units of 8 KB, an FTL map table managed by units of 8 KB is stored in a map region MR1, and therefore, a free space FS1 in the first volatile memory 413-1 may increase by 1 GB, i.e., 50% as compared to when the data is managed by units of 4 KB.

Referring to FIG. 9C, when NAND-type flash memory NAND 470 connected to the first scale-out controller 411-1 is assigned as a sequential read/write data partition and data stored in the NAND-type flash memory NAND 470 is managed by units of 16 KB, an FTL map table managed by units of 16 KB is stored in a map region MR2, and therefore, a free space FS2 in the first volatile memory 413-1 may increase by 1.5 GB, i.e., 75% as compared to when the data is managed by units of 4 KB. Here, it is assumed that 4, 8 and 16 KB are map sizes.

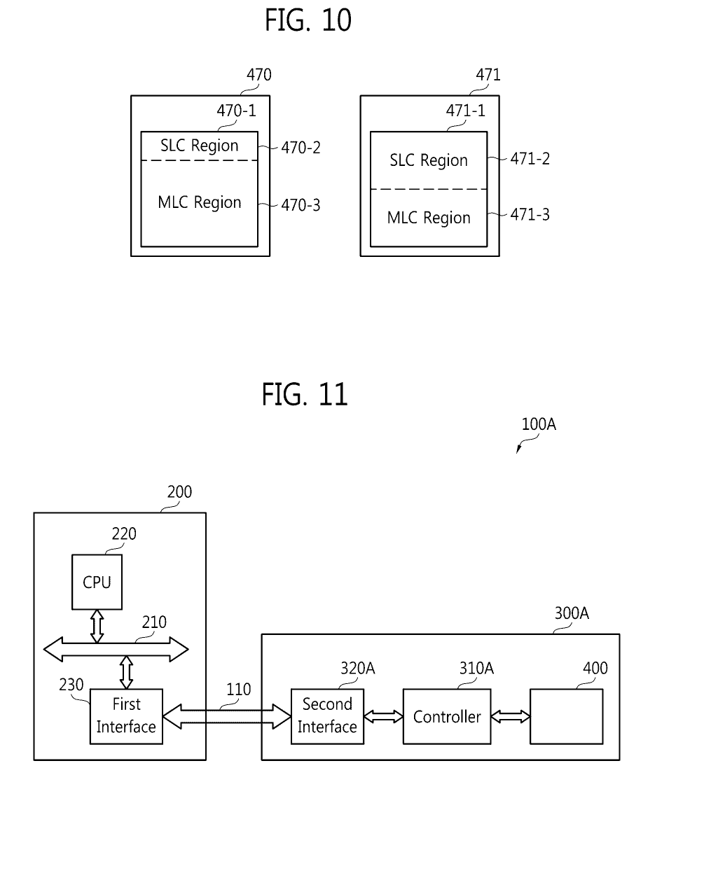

FIG. 10 illustrates a diagram showing a ratio of an SLC region to an MLC region in non-volatile memory shown in FIG. 3. Referring to FIG. 10, the first NAND-type flash memory 470 may include a memory cell array 470-1. The memory cell array 470-1 may include an SLC region 470-2 and an MLC region 470-3. The SLC region 470-2 may include second memory cells that store 1-bit information among first non-volatile memory cells included in the first NAND-type flash memory 470, and the MLC region 470-3 may include third memory cells that store information of at least 2 bits among the first non-volatile memory cells. The first scale-out controller 411-1 may determine a ratio of the number of the second memory cells to be included in the SLC region 470-2 to the number of the third memory cells to be included in the MLC region 470-3, according to a first memory management policy for the first NAND-type flash memory 470.

The second NAND-type flash memory 471 may include a memory cell array 471-1. The memory cell array 471-1 may include an SLC region 471-2 and an MLC region 471-3. The SLC region 471-2 may include fifth memory cells that store 1-bit information among fourth non-volatile memory cells included in the second NAND-type flash memory 471 and the MLC region 471-3 may include sixth memory cells that store information of at least 2 bits among the fourth non-volatile memory cells. The second scale-out controller 411-2 may determine a ratio of the number of the fifth memory cells to be included in the SLC region 471-2 to the number of the sixth memory cells to be included in the MLC region 471-3, according to a second memory management policy for the second NAND-type flash memory 471.

FIG. 11 illustrates a block diagram of a data processing system 100A, according to embodiments of the inventive concept. Referring to FIG. 11, the data processing system 100A includes the host 200 and a data storage device 300A which communicates a command and/or data with the host 200 via the interface 110. The data storage device 300A may have scale-out architecture. The data processing system 100A may be used in a PC, a workstation, a data center, an internet data center, a SAN, a NAS, or a mobile computing device, but the inventive concept is not restricted to these embodiments. The data storage device 300A may be a DRAMless SSD or an eMMC.

The data storage device 300A includes a second interface 320A which communicates with the first interface 230 via the interface 110, and a controller 310A which controls the operations of the memory cluster 400. The data processing system 100A does not include DRAM that functions as the buffer 360, and therefore, the controller 310A does not include the buffer controller 340 unlike the controller 310 illustrated in FIG. 1.

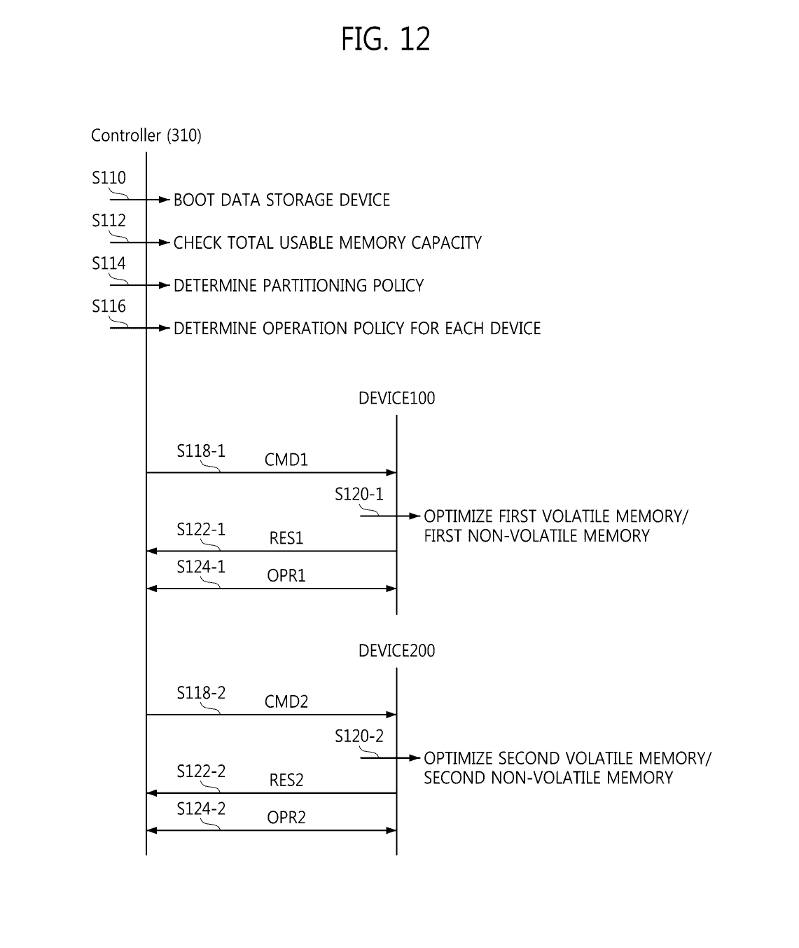

FIG. 12 illustrates a conceptual diagram of the operation of the data storage device 300 or 300A shown in FIG. 1 or 11, according to embodiments of the inventive concept. Referring to FIGS. 1 through 12, when operating voltages are applied to the data processing system 100 or 100A (hereinafter, collectively denoted by numeral 100), the data storage device 300 or 300A (hereinafter, collectively denoted by numeral 300) is booted in operation S110.

The controller 310 or 310A (hereinafter, collectively denoted by numeral 310) or the CPU 330 or 331 checks or detects a total usable memory capacity of the data storage device 300 in operation S112. The controller 310 transmits the check or detection result to the host 200, and the host 200 may display the total usable memory capacity using a display (not shown) connected to the host 200.

The controller 310 or a user of the data storage device 300 determines a partitioning policy based on the total usable memory capacity in operation S114. In detail, firmware executed in the CPU 330 or 331 of the controller 310 checks the total usable memory capacity and determines the partitioning policy based on the check result in operation S114. As described above with reference to FIG. 2, the controller 310 may define the devices 410-1 and 410-2 as the high reliability data partition, the devices 430-1 and 450-1 as the sequential read/write data partition, and the devices 410-3, 410-4, 430-2 through 430-4, and 450-2 through 450-4 as the random read/write data partition in operation S114.

The controller 310 determines a memory management policy for each of the devices included in the memory cluster 400 in operation S116. In detail, the controller 310 or the CPU 330 or 331 transmits a first command corresponding to a first memory management policy to the devices 410-1 and 410-2, a second command corresponding to a second memory management policy to the devices 430-1 and 450-1, and a third command corresponding to a third memory management policy to the devices 410-3, 410-4, 430-2 through 430-4, and 450-2 through 450-4.

It is assumed that a first device DEVICE100 includes a first scale-out controller which controls at least one first non-volatile memory (such as first NAND-type flash memory 470 shown in FIG. 3 for example) included in the first device DEVICE100, and a second device DEVICE200 includes a second scale-out controller which controls at least one second non-volatile memory (such as second NAND-type flash memory 471 shown in FIG. 3 for example) included in the second device DEVICE200. It is also assumed that the first device DEVICE100 is one of the devices 410-1 through 410-4, 430-1 through 430-4, and 450-1 through 450-4, and the second device DEVICE200 is another one of the devices 410-1 through 410-4, 430-1 through 430-4, and 450-1 through 450-4. It is also assumed that the first device DEVICE100 may also include a first volatile memory (such as buffer 413-1 shown in FIG. 3 for example) controlled by the first scale-out controller, and the second device DEVICE200 may also include a second volatile memory (such as buffer 413-2 shown in FIG. 3 for example) controlled by the second scale-out controller, as shown in FIGS. 1 through 3.

According to the above noted assumptions which are merely for the purpose of explanation of an embodiment of the inventive concept and not limiting, the controller 310 determines that the first memory management policy for the first non-volatile memory is different from the second memory management policy for the second non-volatile memory. The controller 310 transmits a first command CMD1 corresponding to the first memory management policy to the first device DEVICE100 in operation S118-1, and transmits a second command CMD2 corresponding to the second memory management policy to the second device DEVICE200 in operation S118-2.

The first scale-out controller included in the first device DEVICE100 optimizes the first non-volatile memory based on the first command CMD1 output from the controller 310 in operation S120-1. The first scale-out controller may also optimize the first volatile memory based on the first command CMD1 output from the controller 310. In other words, the first scale-out controller may set the first memory management policy for the first non-volatile memory based on the first command CMD1 in operation S120-1.

The second scale-out controller included in the second device DEVICE200 optimizes the second non-volatile memory based on the second command CMD2 output from the controller 310 in operation S120-2. The second scale-out controller may also optimize the second volatile memory based on the second command CMD2 output from the controller 310. In other words, the second scale-out controller may set the second memory management policy for the second non-volatile memory based on the second command CMD2 in operation S120-2.

The first scale-out controller transmits to the controller 310 information about a first free space generated in the first volatile memory according to the first memory management policy as a first response RES1 in operation S122-1. For instance, when the first non-volatile memory connected to the first scale-out controller is assigned as the random read/write data partition and data stored in the first non-volatile memory is managed by units of 4 KB, as shown in FIG. 9A, there is no free space in the first volatile memory. At this time, the first scale-out controller may transmit information indicating that there is no first free space in the first volatile memory to the controller 310 as the first response RES1 in operation S122-1.

The second scale-out controller transmits to the controller 310 information about a second free space generated in the second volatile memory according to the second memory management policy as a second response RES2 in operation S122-2. For instance, when the second non-volatile memory connected to the second scale-out controller is assigned as the sequential read/write data partition and data stored in the second non-volatile memory is managed by units of 8 KB, as shown in FIG. 9B, the second scale-out controller may transmit information indicating that the second free space exists in the second volatile memory to the controller 310 as the second response RES2 in operation S122-2.

The controller 310 or the CPU 330 or 331 generates a new command based on the first response RES1. Accordingly, the controller 310 and the first device DEVICE100 may perform a first operation OPR1 corresponding to the new command in operation S124-1. The first operation OPR1 may be a program operation or a read operation.

The controller 310 or the CPU 330 or 331 generates a new command based on the second response RES2. Accordingly, the controller 310 and the second device DEVICE200 may perform a second operation OPR2 corresponding to the new command in operation S124-2. The second operation OPR2 may be a program operation or a read operation.

The first memory management policy for the first non-volatile memory may be a first FTL mapping policy, and the second memory management policy for the second non-volatile memory may be a second FTL mapping policy. At this time, the controller 310 or the CPU 330 or 331 may transmit the first command CMD1 corresponding to the first FTL mapping policy to the first device DEVICE100 in operation S118-1, and may transmit the second command CMD2 corresponding to the second FTL mapping policy to the second device DEVICE200 in operation S118-2. The first FTL mapping policy may indicate a first size (e.g. one among 4 KB, 8 KB, and 16 KB) by units of which first data stored in the first non-volatile memory is managed, and the second FTL mapping policy may indicate a second size (e.g. another one among 4 KB, 8 KB, and 16 KB) by units of which second data stored in the second non-volatile memory is managed.

As an alternative, the controller 310 or the CPU 330 or 331 may transmit, to the first device DEVICE100, the first command CMD1 corresponding to one policy among a page-level mapping policy, a block-level mapping policy, and a hybrid mapping policy in operation S118-1 and may transmit, to the second device DEVICE200, the second command CMD2 corresponding to another policy among the page-level mapping policy, the block-level mapping policy, and the hybrid mapping policy in operation S118-2.

As another alternative, the controller 310 may transmit, to the first device DEVICE100, the first command CMD1 indicating whether to program first data to the first non-volatile memory in one mode among a sequential program mode and a random program mode in operation S118-1. Accordingly, the first scale-out controller of the first device DEVICE100 may determine whether to program the first data to the first non-volatile memory in one mode among the sequential program mode and the random program mode based on the first command CMD1 corresponding to the first memory management policy.

The controller 310 may transmit, to the second device DEVICE200, the second command CMD2 indicating whether to program second data to the second non-volatile memory in the other mode among the sequential program mode and the random program mode in operation S118-2. Accordingly, the second scale-out controller of the second device DEVICE200 may determine whether to program the second data to the second non-volatile memory in the other mode among the sequential program mode and the random program mode based on the second command CMD2 corresponding to the second memory management policy.

As still another alternative, the controller 310 may transmit, to the first device DEVICE100, the first command CMD1 indicating whether to program first data having a first access frequency to the first non-volatile memory included in the first device DEVICE100 in operation S118-1. Accordingly, the first scale-out controller of the first device DEVICE100 may determine whether to program the first data having the first access frequency to the first non-volatile memory based on the first command CMD1 corresponding to the first memory management policy.

The controller 310 may transmit, to the second device DEVICE200, the second command CMD2 indicating whether to program second data having a second access frequency to the second non-volatile memory included in the second device DEVICE200 in operation S118-2. Accordingly, the second scale-out controller of the second device DEVICE200 may determine whether to program the second data having the second access frequency to the second non-volatile memory based on the second command CMD2 corresponding to the second memory management policy. The first access frequency may be higher or lower than the second access frequency.

As yet another alternative, the controller 310 may transmit the first command CMD1 indicating a first ratio to the first device DEVICE100 in operation S118-1. The first scale-out controller included in the first device DEVICE100 may determine the first ratio of the number of second memory cells storing 1-bit information to the number of third memory cells storing information of at least two bits among first non-volatile memory cells included in the first non-volatile memory included in the first device DEVICE100 based on the first command CMD1 corresponding to the first memory management policy, and may apply the first ratio to the first non-volatile memory. Accordingly, the first non-volatile memory may be configured to have an SLC region and an MLC region at the first ratio in operation S120-1.

The controller 310 may transmit the second command CMD2 indicating a second ratio to the second device DEVICE200 in operation S118-2. The second scale-out controller included in the second device DEVICE200 may determine the second ratio of the number of fifth memory cells storing 1-bit information to the number of sixth memory cells storing information of at least two bits among fourth non-volatile memory cells included in the second non-volatile memory included in the second device DEVICE200 based on the second command CMD2 corresponding to the second memory management policy, and may apply the second ratio to the second non-volatile memory. Accordingly, the second non-volatile memory may be configured to have an SLC region and an MLC region at the second ratio in operation S120-2.

As a further alternative, the controller 310 may transmit the first command CMD1 indicating a first ECC code rate to the first device DEVICE100 in operation S118-1. Accordingly, an ECC engine of the first scale-out controller included in the first device DEVICE100 may perform error correction on data at the first ECC code rate. The controller 310 may transmit the second command CMD2 indicating a second ECC code rate to the second device DEVICE200 in operation S118-2. Accordingly, an ECC engine of the second scale-out controller included in the second device DEVICE200 may perform error correction on data at the second ECC code rate.

The first non-volatile memory may include a first three-dimensional memory cell array including first memory cells, and the second non-volatile memory may include a second three-dimensional memory cell array including second memory cells.

Flash memory mentioned above may include a memory cell array. The memory cell array may include a two-dimensional or three-dimensional memory cell array. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In embodiments of the inventive concept, the 3D memory array includes vertical NAND strings that are vertically oriented such that at least one memory cell is located over another memory cell. The at least one memory cell may comprise a charge trap layer.

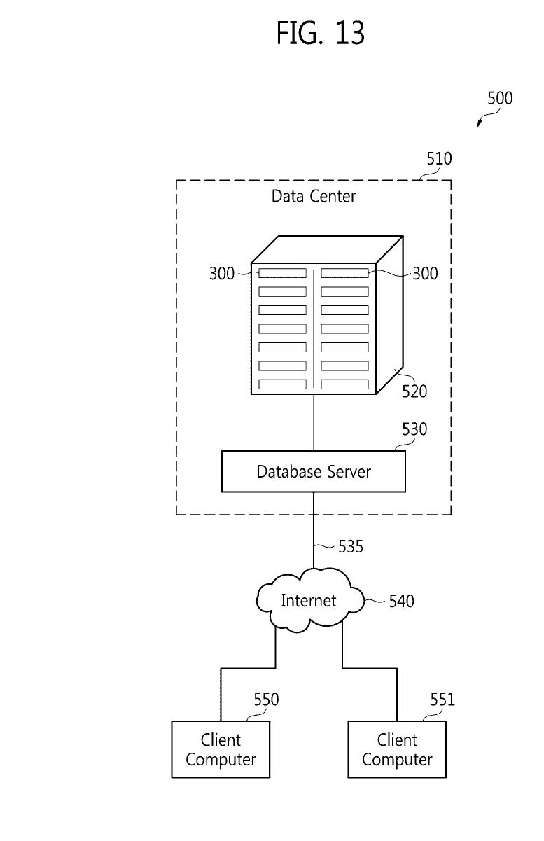

FIG. 13 illustrates a block diagram of a data processing system 500, according to further embodiments of the inventive concept. Referring to FIGS. 1 through 13, the data processing system 500 includes a database 520, a database server 530, a second network 540, and a plurality of client computers 550 and 551. The database 520 and the database server 530 may be included in a data center 510. The data center 510 may be an internet data center or a cloud data center.

The database 520 includes a plurality of data storage devices 300. The plurality of data storage devices 300 may be installed in racks. The structure and operations of the data storage devices 300 are substantially the same as or similar to those of the data storage device 300 described above with reference to FIGS. 1 through 12.

The database server 530 controls the operations of each of the data storage devices 300. The database server 530 is connected to the second network 540, e.g. an internet or Wi-Fi, via a first network 535, e.g. a local area network (LAN). The client computers 550 and 551 are connected to the database server 530 via the second network 540.

As described above, according to embodiments of the inventive concept, a data storage device sets different memory management policies for non-volatile memories controlled by respective scale-out devices, thereby increasing quality of service (QoS). In addition, the data storage device sets a different memory management policy for each device which includes a scale-out device and non-volatile memory controlled by the scale-out device, thereby saving the memory resources of a controller included in the data storage device.

While the inventive concept has been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A data storage device comprising:
a first scale-out controller configured to control a first non-volatile memory and a first volatile memory;
a second scale-out controller configured to control a second non-volatile memory and a second volatile memory; and
a controller configured to set a first memory management policy for the first non-volatile memory to be different from a second memory management policy for the second non-volatile memory.

2. The data storage device of claim 1, wherein the first scale-out controller is configured to set the first memory management policy for the first non-volatile memory based on a first command output from the controller, and the second scale-out controller is configured to set the second memory management policy for the second non-volatile memory based on a second command output from the controller.

3. The data storage device of claim 2, wherein the controller is configured to generate the first command and the second command based on a total usable memory capacity of the data storage device.

4. The data storage device of claim 1, wherein,
the first scale-out controller is configured to transmit, to the controller, information about a first free space generated in the first volatile memory according to the first memory management policy; and
the second scale-out controller is configured to transmit, to the controller, information about a second free space generated in the second volatile memory according to the second memory management policy.

5. The data storage device of claim 1, wherein the first memory management policy is a first flash translation layer (FTL) mapping policy for the first non-volatile memory, and the second memory management policy is a second FTL mapping policy for the second non-volatile memory.

6. The data storage device of claim 5, wherein the first FTL mapping policy indicates a first size of units by which first data stored in the first non-volatile memory is managed, and the second FTL mapping policy indicates a second size of units by which second data stored in the second non-volatile memory is managed.

7. The data storage device of claim 5, wherein,
the first FTL mapping policy is one policy from among a page-level mapping policy, a block-level mapping policy, and a hybrid mapping policy;
the second FTL mapping policy is another policy from among the page-level mapping policy, the block-level mapping policy, and the hybrid mapping policy;
the first volatile memory and the first scale-out controller are packaged into a first package; and
the second volatile memory and the second scale-out controller are packaged into a second package.

8. The data storage device of claim 1, wherein the first scale-out controller is configured to determine whether to program first data to the first non-volatile memory in one mode from among a sequential program mode and a random program mode based on the first memory management policy, and the second scale-out controller is configured to determine whether to program second data to the second non-volatile memory in an other mode from among the sequential program mode and the random program mode based on the second memory management policy.

9. The data storage device of claim 1, wherein the first scale-out controller is configured to determine whether to program first data having a first access frequency to the first non-volatile memory based on the first memory management policy, and the second scale-out controller is configured to determine whether to program second data having a second access frequency different from the first access frequency to the second non-volatile memory based on the second memory management policy.

10. The data storage device of claim 2, wherein the first scale-out controller is configured to determine a ratio of a number of second memory cells storing 1-bit information to a number of third memory cells storing information of at least two bits among first non-volatile memory cells included in the first non-volatile memory based on the first memory management policy, and the second scale-out controller is configured to determine a ratio of a number of fifth memory cells storing 1-bit information to a number of sixth memory cells storing information of at least two bits among fourth non-volatile memory cells included in the second non-volatile memory based on the second memory management policy.

11. The data storage device of claim 1, wherein the first memory management policy and the second memory management policy are respective different error control coding (ECC) code rates.

12. The data storage device of claim 1, wherein the first non-volatile memory includes a first three-dimensional memory cell array including first memory cells and the second non-volatile memory includes a second three-dimensional memory cell array including second memory cells.

13. A data processing system comprising:
a data storage device; and
a host connected to the data storage device via an interface,
wherein the data storage device comprises
a first scale-out controller configured to control a first non-volatile memory and a first volatile memory,
a second scale-out controller configured to control a second non-volatile memory and a second volatile memory, and
a controller configured to set a first memory management policy for the first non-volatile memory to be different from a second memory management policy for the second non-volatile memory.

14. The data processing system of claim 13, wherein the first scale-out controller is configured to set the first memory management policy for the first non-volatile memory based on a first command output from the controller, and the second scale-out controller is configured to set the second memory management policy for the second non-volatile memory based on a second command output from the controller.

15. The data processing system of claim 14, wherein the controller is configured to calculate a total usable memory capacity of the data storage device during a booting operation and generate the first command and the second command based on the calculated total usable memory capacity.

16. A data storage device comprising:
a first scale-out controller configured to control a first non-volatile memory and a first volatile memory;
a second scale-out controller configured to control a second non-volatile memory and a second volatile memory; and
a controller configured to detect a total usable memory capacity of the data storage device, determine a partitioning policy of the data storage device responsive to the detected total usable memory capacity, and determine respective first and second memory management policies,
wherein the first scale-out controller is configured to control the first non-volatile and volatile memories according to the first memory management policy, and the second scale-out controller is configured to control the second non-volatile and volatile memories according to the second memory management policy.

17. The data storage device of claim 16, wherein the first and second memory management policies are selected from among different respective flash translation layer (FTL) mapping policies.

18. The data storage device of claim 16, wherein the first and second memory management policies indicate either one of a sequential program mode and a random program mode.

19. The data storage device of claim 16, wherein the first and second memory management policies indicate a ratio of a number of memory cells storing 1-bit information to a number of memory cells storing at least two bits of information.

20. The data storage device of claim 16, wherein the first and second memory management policies indicate different respective error control coding (ECC) code rates.
